(19) United States
(12) Patent Application Publication
(10) Pub. No.: US 2026/0213331 A1
(43) Pub. Date: Jul. 23, 2026

(54) LOUVRE FOR A PRISMATIC BATTERY CELL FOR THERMAL RUNAWAY PROPAGATION MITIGATION

(71) Applicant: GM Global Technology Operations LLC, Detroit, MI (US)

(72) Inventors: William L. Villaire, Clarkston, MI (US); Mohammad Bazzi, Dearborn, MI (US); Adam S. Kwiatkowski, Commerce, MI (US); Wei Zeng, Oakland Township, MI (US); Frances Remi Villalonga, Royal Oak, MI (US)

(21) Appl. No.: 19/034,941

(22) Filed: Jan. 23, 2025

(51) Int. Cl. H01M 50/342; H01M 10/653; H01M 50/103; H01M 50/209; H01M 50/553

(52) U.S. Cl. CPC H01M 50/3425; H01M 10/653; H01M 50/103; H01M 50/209; H01M 50/553; H01M 2200/20

(57) ABSTRACT

A thermal runaway propagation mitigation system for a prismatic battery cell includes a plurality of louvres. The louvre provides vent control assistance to direct effluent and other particulates on a particular path while also providing sidewall protection for adjacent prismatic battery cells from particulates during a thermal runaway event. The louvre comprises a plurality of terminal windows that align with terminals on the prismatic battery cell and a thermal vent which detaches under an application of pressure. In an embodiment, the louvre is a one-piece “L” shaped design with a top face and a side face. In another embodiment, the louvre is an overlapping design that comprises two “L” shaped pieces. In another embodiment, the louvre is a one-piece “U” shaped design with a top face and two side faces. In another embodiment, the louvre is a two-piece “U” shaped design with a top face and two side faces.

### INTRODUCTION

The present disclosure relates to a louvre for a prismatic battery cell to mitigate thermal runaway propagation.

Electric vehicles and hybrid vehicles employ a high voltage electric battery system that includes a number of battery cells. These electric and hybrid vehicles typically require several battery cells to provide enough power to meet vehicle power and energy requirements. The battery cells are often located under the vehicle body midway between the front and rear wheels.

Battery cells, particularly of the high-voltage type described above, generate substantial amounts of heat during sustained operation and fast charging. Over time, the generated heat may degrade the efficiency and the overall structural integrity of the battery pack or lead to thermal runaway events. A variety of thermal runaway propagation mitigation techniques are therefore used to limit the damage a thermal runaway event can inflict on the battery cells.

Thus, while current thermal runaway propagation mitigation techniques achieve their intended purpose, there is a need for a new and improved system and method for providing vent control assistance and battery cell sidewall protection from effluent and particulates that generate during a thermal runaway event.

### SUMMARY

According to several aspects, a louvre for a prismatic battery cell is provided. The prismatic battery cell may include an upper surface, a first side surface and a second side surface that run along the length of the prismatic battery cell, and a front side surface and a back side surface that run along the width of the prismatic battery cell. The louvre may include a first top face and a first side face, where the first top face is disposed above and is orientated parallel to the upper surface of the prismatic battery cell and the first side face is disposed above and is orientated parallel to either the first side surface or the second side surface of the prismatic battery cell, wherein the first top face comprises a plurality of terminal windows and a thermal vent.

In an additional aspect of the present disclosure, the thermal vent is composed of a weakened material that detaches from the first top face under an application of pressure.

In another aspect of the present disclosure, the plurality of terminal windows align with terminals disposed on the upper surface of the prismatic battery cell.

In an additional aspect of the present disclosure, the first top face and the first side face comprise a single piece molded in an “L” shape where an edge of the first top face is affixed perpendicularly to an edge of the first side face.

In another aspect of the present disclosure, the first side face is disposed above and is orientated parallel to either the first side surface or the second side surface of the prismatic battery cell, and a second side face, where the second side face is disposed above and is orientated parallel to whichever side surface is opposite to where the first side face is disposed.

In an additional aspect of the present disclosure, a second top face and the first top face and the second top face comprise half the surface area of the upper surface of the prismatic battery cell.

In another aspect of the present disclosure, the first top face and the first side face comprise a single piece molded in an “L” shape where an edge of the first top face is affixed perpendicularly to an edge of the first side face, and the second top face and the second side face comprise a single piece molded in an “L” shape where an edge of the second top face is affixed perpendicularly to an edge of the second side face.

In an additional aspect of the present disclosure, the top face, first side face, and second side face comprise a single piece molded in a “U” shape, where an edge of the top face is affixed perpendicularly to an edge of the first side face and an edge of the second side face is affixed to the opposite edge of the top face where the first side face is affixed.

In another aspect of the present disclosure, a first top face and a second top face where the second top face is disposed above and is orientated parallel to the first top face.

In an additional aspect of the present disclosure, the first top face and the first side face comprise a single piece molded in an “L” shape where an edge of the first top face is affixed perpendicularly to an edge of the first side face, and the second top face and the second side face comprise a single piece molded in an “L” shape where an edge of the second top face is affixed perpendicularly to an edge of the second side face.

In another aspect of the present disclosure, a first thinned piece within the first top face and a second thinned piece within the second top face comprise the thermal vent.

In an additional aspect of the present disclosure, the material of the louvre is a phyllosilicate from the mica group with thermal conductivity between 0.1 W/mk to 0.6 W/mk.

In another aspect of the present disclosure, the louvre has a thickness between 0.5 millimeters and 0.7 millimeters.

In an additional aspect of the present disclosure, the louvre may be affixed to the prismatic battery cell using a pressure sensitive adhesive.

In another aspect of the present disclosure, there is a plurality of prismatic battery cells and a plurality of louvres, with each individual prismatic battery cell having a respective louvre.

In an additional aspect of the present disclosure, there is a thermal barrier between each of the plurality of prismatic battery cells.

In another aspect of the present disclosure, the louvre is within a vehicle.

According to several aspects, a louvre for a prismatic battery cell is provided. The prismatic battery cell may include an upper surface, a first side surface and a second side surface that run along the length of the prismatic battery cell, and a front side surface and a back side surface that run along the width of the prismatic battery cell. The louvre may include a first top face, a second top face, a first side face, and a second side face, wherein the first top face and the second top face are disposed above and is orientated parallel to the upper surface of the prismatic battery cell, the first side face is disposed above and is orientated parallel to either the first side surface or second side surface of the prismatic battery cell, and the second side face is disposed above and is orientated parallel to the opposite side surface of the prismatic battery cell in which the first side face is disposed above wherein the first top face and the second top face comprise half the surface area of the upper surface of the prismatic battery cell, a plurality of openings within the first top face and the second top face together form a plurality of terminal windows and a first thinned piece within the first top face and a second thinned piece within the second top face form a thermal vent.

In another aspect of the present disclosure, the first top face and the first side face comprise a single piece molded in an “L” shape where an edge of the first top face is affixed perpendicularly to an edge of the first side face and the second top face and the second side face comprise a single piece molded in an “L” shape where an edge of the second top face is affixed perpendicularly to an edge of the second side face.

According to several aspects, a louvre for a prismatic battery cell is provided. The prismatic battery cell may include an upper surface, a first side surface and a second side surface that run along the length of the prismatic battery cell, and a front side surface and a back side surface that run along the width of the prismatic battery cell. The louvre may include a top face, a first side face, and a second side face, where the top face is disposed above and is orientated parallel to the upper surface of the prismatic battery cell, the first side face is disposed above and is orientated parallel to the first side surface of the prismatic battery cell, and the second side face is disposed above and is orientated parallel to the second side surface of the prismatic battery cell wherein the top face, first side face, and second side face comprise a single piece molded in a “U” shape, where an edge of the top face is affixed perpendicularly to an edge of the first side face and an edge of the second side face is affixed to the opposite edge of the top face where the first side face is affixed and the top face comprises a plurality of terminal windows and a thermal vent.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of an exemplary vehicle having a battery pack comprising a plurality of prismatic battery cells and a thermal runaway propagation mitigation system according to an exemplary embodiment;

FIG. 2 is a perspective view of a louvre with a one-piece “L” shaped design according to an exemplary embodiment;

FIG. 3A is a side view of an alternate embodiment of the louvre with a two-piece “L” shaped overlapping design according to an exemplary embodiment;

FIG. 3B is a top view of the louvre with a two-piece “L” shaped overlapping design according to an exemplary embodiment;

FIG. 4 is a perspective view of an alternate embodiment of the louvre with a one-piece “U” shaped design according to an exemplary embodiment; and

FIG. 5 is a perspective view of an alternate embodiment of the louvre with a two-piece “U” shaped design according to an exemplary embodiment.

### DETAILED DESCRIPTION

The following description is merely exemplary in nature and is not intended to limit the present disclosure, application, or uses.

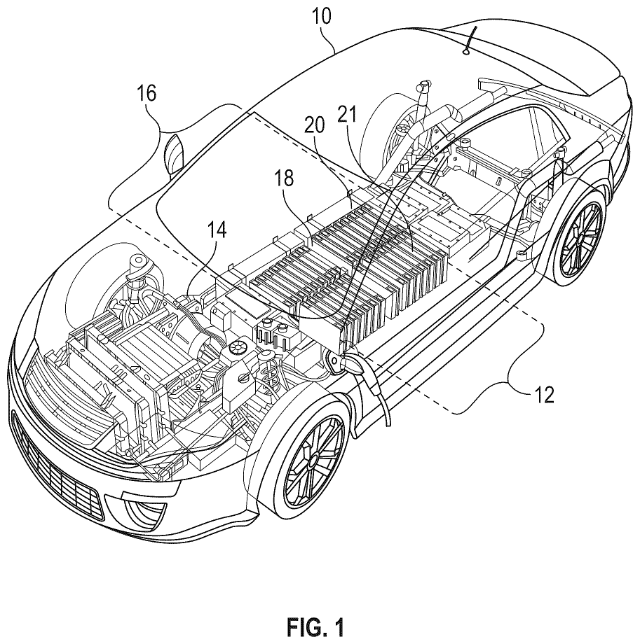

Referring to FIG. 1, an exemplary vehicle 10 having a battery pack 12 for providing power to an electric motor 14 is shown. While the vehicle 10 is illustrated as a passenger car, it should be appreciated that the vehicle may be any type of vehicle, including a truck, a boat, a drone, an airplane, etc., without departing from the scope of the present disclosure. The electric motor 14 provides motive power to the vehicle 10. However, the battery pack 12 may be used in a variety of other electromobility and stationary applications and may be used to power other electrical hardware without departing from the scope of the present disclosure. The battery pack 12 includes a plurality of prismatic battery cells 16 that are electrically connected to one another. The battery pack 12 is supported by a battery enclosure 18 (top and sides of the battery enclosure not shown). The prismatic battery cells 16 generally include a housing 20 that encloses an electrode stack (not shown) and an electrolyte (not shown) for generating energy. During use and charging, the prismatic battery cells 16 generate heat. In order to mitigate this heat, and to mitigate the chance of thermal runaway propagation, the battery pack 12 further includes a plurality of louvres 21, where each prismatic battery cell has a respective louvre.

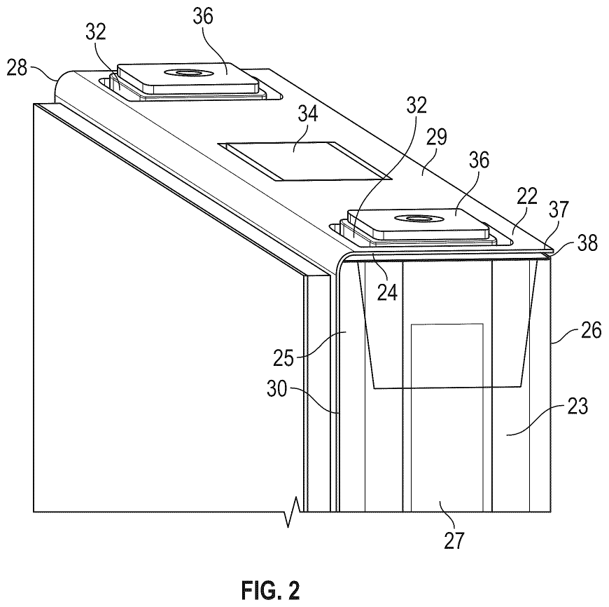

Referring to FIG. 2, a louvre with a one-piece “L” shaped design is generally indicated by reference number 22 (hereinafter the one-piece “L” louvre 22). The one-piece “L” louvre 22 is configured to be placed overtop the prismatic battery cell 16. The one-piece “L” louvre 22 protects adjacent prismatic battery cells from an effluent that would erupt from one of the prismatic battery cells 16 in the event of a thermal runaway event. The one-piece “L” louvre 22 also provides an energy reducing venting path for the effluent.

Each prismatic battery cell 16 has an upper surface 24, a first length side surface 25 and a second length side surface 26 that run along the length of the prismatic battery cell 16. Each prismatic battery cell 16 also has a first width side surface 27 and a second width side surface 28 that run along the width of the prismatic battery cell 16. Each prismatic battery cell 16 also has a battery cell thermal vent 35 (not shown). The battery cell thermal vent 35 is an area designed to fail during thermal runaway before other portions of the upper surface 24 fail. For example, the battery cell thermal vent 35 has a cross-sectional thickness less than a cross-sectional thickness of the remaining portion of the upper surface 24. The weakened area of the battery cell thermal vent 35 causes the battery cell thermal vent 35 to detach from the upper surface 24 while under an application of pressure. In another example, the battery cell thermal vent 35 may be defined by a perforated edge (not shown). The perforated edge weakens a contour of the battery cell thermal vent 35 causing the battery cell thermal vent 35 to detach from the upper surface 24 while under an application of pressure, such as the application of pressure from the effluent during a thermal runaway propagation. Each prismatic battery cell 16 also has a plurality of terminals 36, which provide a connection point for an electrical current to flow from the prismatic battery cell 16 to the vehicle 10 in order to power the vehicle 10.

The one-piece “L” louvre 22 may be composed of material such as, but not limited to, mica, or a phyllosilicate material within the mica group, or a similar material that has a thermal conductivity between 0.1 W/mk to 0.6 W/mk. The thickness of the material that composes the one-piece “L” louvre 22 is between 0.5 millimeters and 0.7 millimeters.

The one-piece “L” louvre 22 comprises a top face 29 and a side face 30. The top face 29 is disposed above and is orientated parallel to the upper surface 24 of the prismatic battery cell 16. The top face 29 comprises a plurality of terminal windows 32 and a louvre thermal vent 34. The plurality of terminal windows 32 are openings within the top face 29 aligned with the plurality of terminals 36 on the upper surface 24 of the prismatic battery cell 16, allowing the terminals 36 to extend through the top face 29.

The louvre thermal vent 34 is disposed within an upper aspect 37 of the top face 29 and extends to a lower aspect 38 of the top face 29. The louvre thermal vent 34 is aligned with the battery cell thermal vent 35 disposed in the top surface of the prismatic cell 16. The louvre thermal vent 34 is an area designed to fail during thermal runaway before other portions of the top face 29 fail. For example, the louvre thermal vent 34 has a cross-sectional thickness less than a cross-sectional thickness of the remaining portion of the top face 29. The weakened area of the louvre thermal vent 34 causes the louvre thermal vent 34 to detach from the top face 29 while under an application of pressure. In another example, the louvre thermal vent 34 may be defined by a perforated edge (not shown). The perforated edge weakens a contour of the louvre thermal vent 34 causing the louvre thermal vent 34 to detach from the top face 29 while under an application of pressure, such as the application of pressure from the effluent during a thermal runaway propagation.

The side face 30 is disposed above and is orientated parallel to either the first length side surface 25 or the second length side surface 26 of the prismatic battery cell 16. An edge of the top face 29 is affixed perpendicularly to an edge of the side face 30, forming a single molded piece in an “L” shape. The top face 29 and the side face 30 are secured to the upper surface 24 and to either the first length side surface 25 or the second length side surface 26 respectively. In a non-limiting example, the top face 29 and the side face 30 are secured to the upper surface 24 and to either the first length side surface 25 or the second length side surface 26 by means of a thermoplastic polymer adhesive. The thermoplastic polymer adhesive is also a pressure sensitive adhesive. In a non-limiting example, the thermoplastic polymer adhesive is a polypropylene tape.

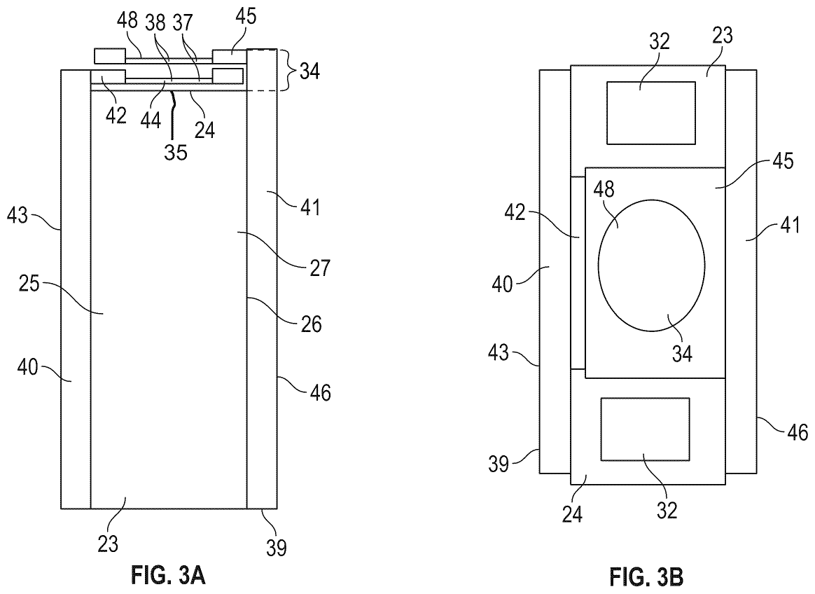

Referring to FIGS. 3A and 3B, a side view of an alternate embodiment of the louvre with a two-piece “L” shaped overlapping design is generally indicated by reference number 39 (hereinafter the overlapping louvre 39). The overlapping louvre 39 has the same properties and functionality as the one-piece “L” louvre 22.

The overlapping louvre 39 comprises a first “L” shaped piece 40 and a second “L” shaped piece 41. The first “L” shaped piece comprises a first top face 42 and a first side face 43. The first top face 42 is disposed above and is orientated parallel to the upper surface 24 of the prismatic battery cell 16. The first top face 42 comprises a first plurality of openings 47 that are aligned with the terminals 36 of the prismatic battery cell 16, and a first thinned piece 44. The first side face 43 is disposed above and is orientated parallel to either the first length side surface 25 or the second length side surface 26 of the prismatic battery cell 16. An edge of the first top face 42 is affixed perpendicularly to an edge of the first side face 43, forming a single molded piece in an “L” shape.

The second “L” shaped piece 41 comprises a second top face 45 and a second side face 46. The second top face 45 is disposed above and is orientated parallel to first top face 42.

The second top face 45 comprises a second plurality of openings 49 that are aligned with the terminals 36 of the prismatic battery cell 16 and the first plurality of openings. Together, the first plurality of openings and the second plurality of openings form the plurality of terminal windows 32, which have the same properties and functionality as previously described. The second top face 45 also comprises a second thinned piece 48, which is aligned with the first thinned piece 44 and together form the louvre thermal vent 34, which has the same properties and function as previously described.

The second side face 46 is disposed above and is orientated parallel to the opposite length side surface of the prismatic battery cell 16 that the first side face 43 is disposed above. An edge of the second top face 45 is affixed perpendicularly to an edge of the second side face 46, forming a single molded piece in an “L” shape.

It should be appreciated that the first “L” shaped piece 40 and the second “L” shaped piece 41 are identical and interchangeable, meaning the second “L” shaped piece 41 can take the currently described position of the first “L” shaped piece 40 and the first “L” shaped piece can take the currently described position of the second “L” shaped piece 41. It should also be appreciated that the first top face 42 and the second top face 45 are identical and interchangeable. It should also be appreciated that the first side face 43 and the second side face 46 are identical and interchangeable.

The first “L” shaped piece 40 is secured to the second “L” shaped piece 41 by means of, in a non-limiting example, the thermoplastic polymer adhesive, which is placed on the first top face 42, second top face 45, first side face 43, and second side face 46. The first “L” shaped piece 40 and the second “L” shaped piece are secured to the upper surface 24 and to both the first length side surface 25 and the second length side surface 26 of the prismatic battery cell 16 by means of, in a non-limiting example, the thermoplastic polymer adhesive.

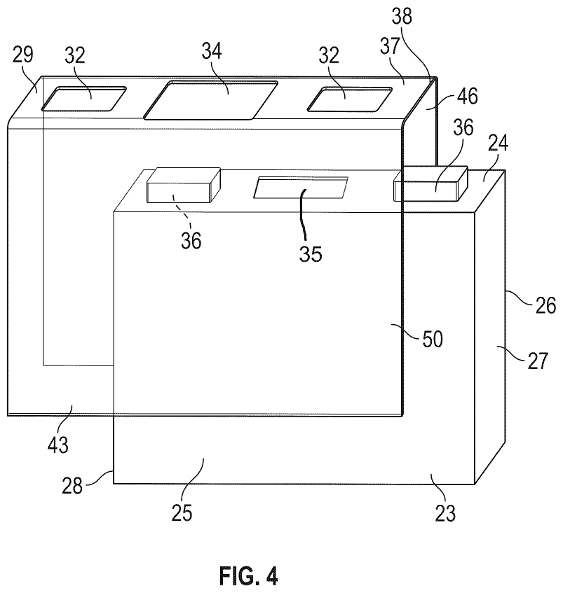

Referring to FIG. 4, a perspective view of an alternate embodiment of the louvre with a one-piece “U” shaped design is generally indicated by reference number 50 (hereinafter the one-piece “U” louvre 50). The one-piece “U” louvre 50 has the same properties and functionality as the one-piece “L” louvre 22.

The one-piece “U” louvre 50 comprises the top face 29, the first side face 43, and the second side face 46. The top face 29 is disposed above and is orientated parallel to the upper surface 24 of the prismatic battery cell 16. The top face 29 comprises the plurality of terminal windows 32 and the louvre thermal vent 34, which have the same properties and function as previously described. The first side face 43 is disposed above and is orientated parallel to either the first length side surface 25 or the second length side surface 26 of the prismatic battery cell 16. The second side face 46 is disposed above and is orientated parallel to the opposite length side surface of the prismatic battery cell 16 that the first side face 43 is disposed above. An edge of the top face 29 is affixed perpendicularly to an edge of the first side face 43 and the second side face 46 is affixed perpendicularly to the edge of the top face 29 opposite to the edge where the first side face 43 is affixed, forming a single molded piece in an “U” shape.

The one-piece “U” louvre 50 is secured to the upper surface 24 and to both the first length side surface 25 and the second length side surface 26 of the prismatic battery cell 16 respectively by means of, in a non-limiting example, the thermoplastic polymer adhesive, which is placed on the top face 29, first side face 43, and second side face 46.

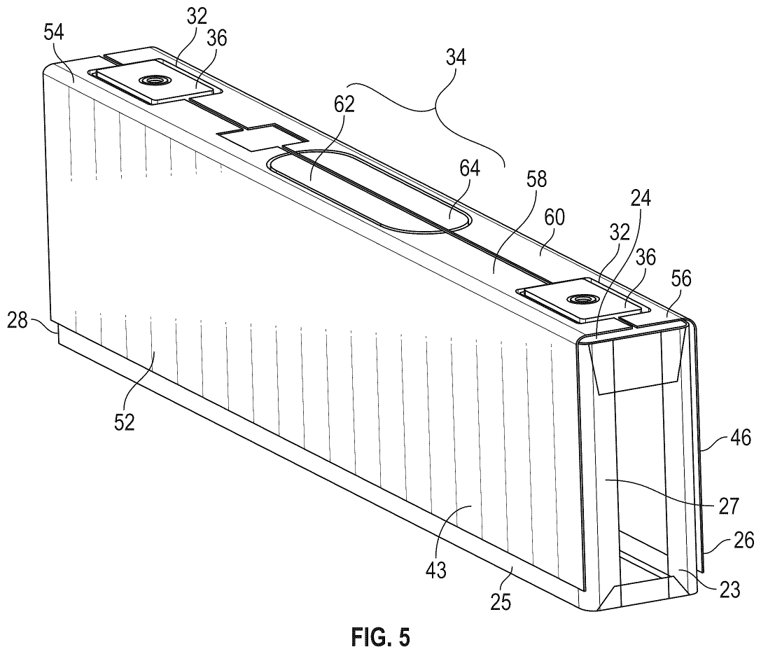

Referring to FIG. 5, a perspective view of an alternate embodiment of the louvre with a two-piece “U” shaped design from the plurality of louvres 18 is generally indicated by reference number 52 (hereinafter the two-piece “U” louvre 52). The two-piece “U” louvre 52 has the same properties and functionality as the one-piece “L” louvre 22.

The two-piece “U” louvre 52 comprises a first piece 54 and a second piece 56. The first piece 54 comprises a first top half-face 58 and the first side face 43. The second piece 56 comprises a second top half-face 60 and the second side face 46. The first top half-face 58 is disposed above and is orientated parallel to the upper surface 24 of the prismatic battery cell 16, covering half the upper surface 24 of the prismatic battery cell 16. The second top half-face 60 is disposed above and is orientated parallel to the upper surface 24 of the prismatic battery cell 16, covering half the upper surface 24 of the prismatic battery cell 16. It should be appreciated that the first top half-face 58 and the second top half-face 60 are identical and interchangeable. An edge of the first top half-face 58 and an edge of the second top half-face 60 have a plurality of openings that align with one another to form the plurality of terminal windows 32. The first top half-face 58 and the second top half-face 60 further comprise a first half thinned piece 62 and a second half thinned piece 64 that align with one another to form the louvre thermal vent 34. The plurality of terminal windows 32 and the louvre thermal vent 34 have the same properties and functionality as previously described.

The first side face 43 is disposed above and is orientated parallel to either the first length side surface 25 or the second length side surface 26 of the prismatic battery cell 16. The second side face 46 is disposed above and is orientated parallel to the opposite length side surface of the prismatic battery cell 16 that the first side face 43 is disposed above. An edge of the first top half-face 58 is affixed perpendicularly to an edge of the first side face 43, forming the first piece 54. An edge of the second top half-face 60 is affixed perpendicularly to an edge of the second side face 46, forming the second piece 56. It should be appreciated that the first piece 54and the second piece 56 are identical and interchangeable. When the first piece 54 and the second piece 56 are secured adjacent to each other on the prismatic battery cell 16, the “U” shape of the two-piece “U” louvre 52 is formed.

The two-piece “U” louvre 52 is secured to the upper surface 24 and to both the first length side surface 25 and the second length side surface 26 of the prismatic battery cell 16 respectively by means of, in a non-limiting example, the thermoplastic polymer adhesive, which is placed on the first top half-face 58, second top half-face 60, first side face 43, and second side face 46.

The one-piece “L” louvre 22, overlapping louvre 39, one-piece “U” louvre 50, and two-piece “U” louvre 52 of the present disclosure offer several advantages. These include vent control assistance to direct the effluent on a particular path in the event thermal runaway occurs and sidewall protection from the effluent and other particulates for adjacent prismatic battery cells to the prismatic battery cell 16 that is suffering from a thermal runaway event.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A louvre for a prismatic battery cell, the prismatic battery cell having an upper surface, a first side surface and a second side surface that run along the length of the prismatic battery cell, and a front side surface and a back side surface that run along the width of the prismatic battery cell, the louvre having:
a first top face and a first side face, where the first top face is disposed above and is orientated parallel to the upper surface of the prismatic battery cell and the first side face is disposed above and is orientated parallel to either the first side surface or the second side surface of the prismatic battery cell; and
wherein the first top face comprises a plurality of terminal windows and a thermal vent.

2. The louvre from claim 1, wherein the thermal vent is composed of a weakened material that detaches from the first top face under an application of pressure.

3. The louvre from claim 1, wherein the plurality of terminal windows align with terminals disposed on the upper surface of the prismatic battery cell.

4. The louvre from claim 1, wherein the first top face and the first side face comprise a single piece molded in an “L” shape where an edge of the first top face is affixed perpendicularly to an edge of the first side face.

5. The louvre from claim 1, wherein the first side face is disposed above and is orientated parallel to either the first side surface or the second side surface of the prismatic battery cell, and a second side face, where the second side face is disposed above and is orientated parallel to whichever side surface is opposite to where the first side face is disposed.

6. The louvre from claim 5, wherein a second top face and the first top face and the second top face comprise half the surface area of the upper surface of the prismatic battery cell.

7. The louvre from claim 6, wherein the first top face and the first side face comprise a single piece molded in an “L” shape where an edge of the first top face is affixed perpendicularly to an edge of the first side face, and the second top face and the second side face comprise a single piece molded in an “L” shape where an edge of the second top face is affixed perpendicularly to an edge of the second side face.

8. The louvre from claim 5, wherein the top face, first side face, and second side face comprise a single piece molded in a “U” shape, where an edge of the top face is affixed perpendicularly to an edge of the first side face and an edge of the second side face is affixed to the opposite edge of the top face where the first side face is affixed.

9. The louvre from claim 5, wherein a first top face and a second top face where the second top face is disposed above and is orientated parallel to the first top face.

10. The louvre from claim 9 wherein the first top face and the first side face comprise a single piece molded in an “L” shape where an edge of the first top face is affixed perpendicularly to an edge of the first side face, and the second top face and the second side face comprise a single piece molded in an “L” shape where an edge of the second top face is affixed perpendicularly to an edge of the second side face.

11. The louvre from claim 10, wherein a first thinned piece within the first top face and a second thinned piece within the second top face comprise the thermal vent.

12. The louvre from claim 1, wherein the material of the louvre is a phyllosilicate from the mica group with thermal conductivity between 0.1 W/mk to 0.6 W/mk.

13. The louvre from claim 1, wherein the louvre has a thickness between 0.5 millimeters and 0.7 millimeters.

14. The louvre from claim 1, wherein the louvre is affixed to the prismatic battery cell using a pressure sensitive adhesive.

15. The louvre from claim 1, wherein there is a plurality of prismatic battery cells and a plurality of louvres, with each individual prismatic battery cell having a respective louvre.

16. The louvre from claim 15, wherein there is a thermal barrier between each of the plurality of prismatic battery cells.

17. The louvre from claim 1, wherein the louvre is within a vehicle.

18. A louvre for a prismatic battery cell, the prismatic battery cell having an upper surface, a first side surface and a second side surface that run along the length of the prismatic battery cell, and a front side surface and a back side surface that run along the width of the prismatic battery cell, the louvre having:
a first top face, a second top face, a first side face, and a second side face, wherein the first top face and the second top face are disposed above and is orientated parallel to the upper surface of the prismatic battery cell, the first side face is disposed above and is orientated parallel to either the first side surface or second side surface of the prismatic battery cell, and the second side face is disposed above and is orientated parallel to the opposite side surface of the prismatic battery cell in which the first side face is disposed above;
wherein the first top face and the second top face comprise half the surface area of the upper surface of the prismatic battery cell;
wherein a plurality of openings within the first top face and the second top face together form a plurality of terminal windows; and
wherein a first thinned piece within the first top face and a second thinned piece within the second top face form a thermal vent.

19. The louvre from claim 7, wherein the first top face and the first side face comprise a single piece molded in an “L” shape where an edge of the first top face is affixed perpendicularly to an edge of the first side face and the second top face and the second side face comprise a single piece molded in an “L” shape where an edge of the second top face is affixed perpendicularly to an edge of the second side face.

20. A louvre for a prismatic battery cell, the prismatic battery cell having an upper surface, a first side surface and a second side surface that run along the length of the prismatic battery cell, and a front side surface and a back side surface that run along the width of the prismatic battery cell, the louvre having:
a top face, a first side face, and a second side face, where the top face is disposed above and is orientated parallel to the upper surface of the prismatic battery cell, the first side face is disposed above and is orientated parallel to the first side surface of the prismatic battery cell, and the second side face is disposed above and is orientated parallel to the second side surface of the prismatic battery cell;
wherein the top face, first side face, and second side face comprise a single piece molded in a “U” shape, where an edge of the top face is affixed perpendicularly to an edge of the first side face and an edge of the second side face is affixed to the opposite edge of the top face where the first side face is affixed; and
wherein the top face comprises a plurality of terminal windows and a thermal vent.
